(19) United States
(12) Patent Application Publication
(10) Pub. No.: US 2025/0000290 A1
(43) Pub. Date: Jan. 2, 2025

(54) IMPROVEMENTS TO UTENSILS FOR USE IN SECURE AREAS

(71) Applicant: Detectamet Limited, Pocklington, Yorkshire (GB)

(72) Inventor: Sean Ronald Smith, Richmond, VA (US)

(73) Assignee: Detectamet Limited, Pocklington, Yorkshire (GB)

(21) Appl. No.: 18/703,868

(22) PCT Filed: Nov. 2, 2022
(86) PCT No.: PCT/GB2022/052760

§ 371 Date: Apr. 23, 2024

(30) Foreign Application Priority Data
Nov. 2, 2021 (GB) 2115688.0

(51) Int. Cl. A47G 21/00; G01V 5/22

(52) U.S. Cl. CPC A47G 21/00; G01V 5/224; A47G 2400/10

(57) ABSTRACT

The present invention provides a system for detecting the removal of an item or items from a secure area. The system includes a secure area in which the item or items are located, one or more entrances to and/or exits from the secure area, one or more items, those items provided to be formed of a plastics or other polymeric material, and the item or items further including a plurality of metal detectable particles and/or X-ray detectable material embedded within the plastics material. Detection or sensor apparatus are provided to be located at the one or more entrances to and/or exits of the secure area, arranged to detect or sense the passage of metal detectable particles and/or X-ray detectable material therethrough, in use.

The invention to which this application relates is to improvements to utensils and, items in general, which are provided to be used in secure areas or restricted environments such as prisons, post-security airport lounges or other secure facilities and which, it is desired, are retained in the secure area after use for, as and when removed from the secure area are removed in a control manner and by authorised personnel.

It is known that utensils may also be used for their intended purpose in a secure area and then, after their intended use, attempts may be made to smuggle or otherwise remove the item from the secure area following which, or before which, the said item or utensil may be adapted for another purpose.

For example, in a prison environment, where utensils are provided in the form of knives and forks, for use by prison inmates when eating food in a canteen area, attempts can be subsequently made to remove the items from the canteen area and into the prison environment so as to be used as a weapon. In another example, in an airport and after the security checks have been made, utensils are typically provided in a form so as to minimise the possibility of the utensils being used as a weapon for example, if the same are carried onto a plane.

Thus, at present, there are two options available for minimising the risk of utensils present in a secure area being smuggled or leaving the secure area in an unauthorised manner.

A first option is to manufacture the utensil or provide the utensil in a form, which means that the utensil is less likely to be able to be used as a weapon or for other purposes. However, a problem with this is that the utensil may in itself become unusable for its intended authorised purpose and even then, the utensil may be subsequently adapted so as to render the utensil into a form which can be used as an offensive weapon.

An alternative form is to provide the utensil of a material which is easily detectable by standard detection apparatus but, this means that if the utensil is smuggled out, of the secure area then the tier from which the same is formed, becomes problematic and the utensil is easily used as an offensive weapon.

The aim of the present invention is therefore to provide utensils in a form which allow the same to be provided in a suitable format for use for its intended purpose in a secure area and, at the same time, render the same detectable should attempts be made to remove the item from the secure area while, at the same time, allowing the utensil to be of a form which means that the item is less easily usable as an offensive weapon.

It is a further aim of the present invention to provide a system wherein such utensils may be used within a predefined area and any attempt made to remove the utensil from the said area can be readily detected.

In accordance with the first aspect of the invention, there is provided a utensil provided for use in an intended purpose in a secure area,
said utensil formed of a plastics or other polymeric material and in a manner to allow the same to be useable for its intended purpose, and
said utensil further including embedded within the plastics material, a plurality of metal detectable particles and/or X-ray detectable material, such that when an attempt is made to remove the same from the secure area, detection apparatus located at exits from the secure area will detect the presence of said utensil.

Thus, in accordance with the invention, there is provided the possibility of manufacturing the utensil of the material which, is less able to cause the utensil to be used as an offensive weapon and, at the same time, allows the utensil to still be detectable by metal and/or X-ray detection apparatus so as to allow the prevention of movement of the utensil from the secure area.

Typically, the secure area is a designated area of a building or environment, such as for example, a canteen, workshop or specific room or rooms in which utensils may be required to be utilised whilst, at the same time, preventing the removal of those utensils into other areas in which the same are not required and for which the purpose is more likely to be an unauthorised purpose.

Typically, the level of metal detectable particles and/or X-ray detectable material will be sufficient so as to ensure that the utensil, and more preferably, a predefined size or portion of the material, to be detectable by metal detection and/or X-ray detection apparatus.

Typically, the type of apparatus which will be used to attempt to detect said utensils or portions thereof, will be known and have known detection parameters such that only utensils which are known to be detectable by said apparatus will be made available in the secure area and thereby ensure that the utensils or portions thereof are detected by the detection apparatus which is in use at that time.

In one embodiment, the metal particles which are used are ferrous metals or metal-compounds. Typically, said ferrous metals or metal compounds may include iron oxide derivatives. In one embodiment said metal-detectable particles are provided as particles of magnetite (Fe₂O₃).

Typically, said X-ray detectable material may be provided from iodine or barium derivatives. In one embodiment, said X-ray detectable material may be barium sulphate (BaSO₄).

In another aspect of the present invention there is provided a system for detecting the removal of an item or items from a secure area, said system including:
a secure area in which said item or items are located;
one or more entrances to and/or exits from said secure area;
said items provided to be formed of a plastics or other polymeric material;
said item or items further including a plurality of metal detectable particles and/or X-ray detectable material embedded within the plastics material; and
detection or sensor apparatus located at the one or more entrances to and/or exits of said secure area, arranged to detect or sense the passage of metal detectable particles and/or X-ray detectable material therethrough, in use.

Typically, when an attempt is made to remove the item or items from the secure area, the said detection or sensor apparatus located at the entrances and/or exits from the secure area will detect their presence, in use. Consequently, security personnel can act upon said detection and prevent the removal of said item or items from the secure area.

Typically, said item or items are formed as utensils to be used during the preparation, serving and/or consumption of food and/or drink within the secure area.

In one embodiment, said secure area is provided to be a canteen, dining area, workshop or specific room or rooms in which said item or items may be required to be utilised or the like within a prison, jail, penitentiary, or other such restricted location.

In another embodiment, said secure area is provided to be within an airport location after the point where standard security checks are carried out.

In one embodiment, said metal detectable particles and/or X-ray detectable material is embedded throughout the item or items such that after any attempt to shave, snap, cut, sharpen, reshape or otherwise alter the shape, size or appearance of the item or items, the said metal detectable particles and/or X-ray detectable material will remain present within the altered item or items, and thus be detectable by the detection or sensor apparatus, in use.

In one embodiment, notification means are provided associated with said detection or sensor apparatus. Typically, in use, as an item or items comprising the metal detectable particles and/or X-ray detectable material is attempted to be taken from the secure area, said item or items will be detected and the apparatus will notify security personnel of the detection, enabling them to prevent or deter the removal of the item from the secure area.

The present invention therefore provides a means by which to detect the attempted removal of an item or items from a secure area to be taken into another area for an alternative use. The system is particular advantageous in that even if a degree of alteration or manipulation of the item or items is successfully achieved by a person within the secure area, metal detectable particles and/or X-ray detectable material will still be present in a sufficient amount throughout the altered or manipulated item or items, to be detected by the detection or sensor apparatus upon the attempted removal from the secure area of that item or items.

The present invention has particular use in, for example, a prison environment wherein standard culinary utensils may be attempted to be taken from a canteen or dining area to be reshaped into an offensive weapon for use in another area of the prison environment—the present invention serves to prevent such instances from occurring and thus substantially reduce the occurrence of potentially violent incidents within that environment. Moreover, in the case when items have been removed from their designated area, metal detectability provides an axis of identification to locate missing parts in the banned area.

In another aspect of the present invention there is provided a set of culinary utensils:
said utensils provided for the preparation, serving and/or consumption of food and/or drink in a secure area;
said utensils formed of a plastics or other polymeric material and in a manner to allow the same to be useable for their intended purpose;
said utensils further including embedded within the plastics material, a plurality of metal detectable particles and/or X-ray detectable material, arranged such that when an attempt is made to remove the same from the secure area, detection apparatus located at entrances and/or exits from the secure area will detect the presence of said utensils.

Specific embodiments of the invention are now described with reference to the accompanying drawings wherein:

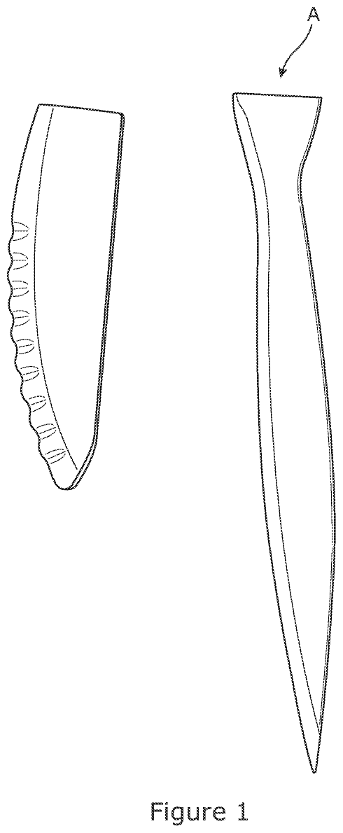

FIG. 1 illustrates a conventional utensil which has been adapted for use as an offensive weapon following removal of the utensil from a secure area;

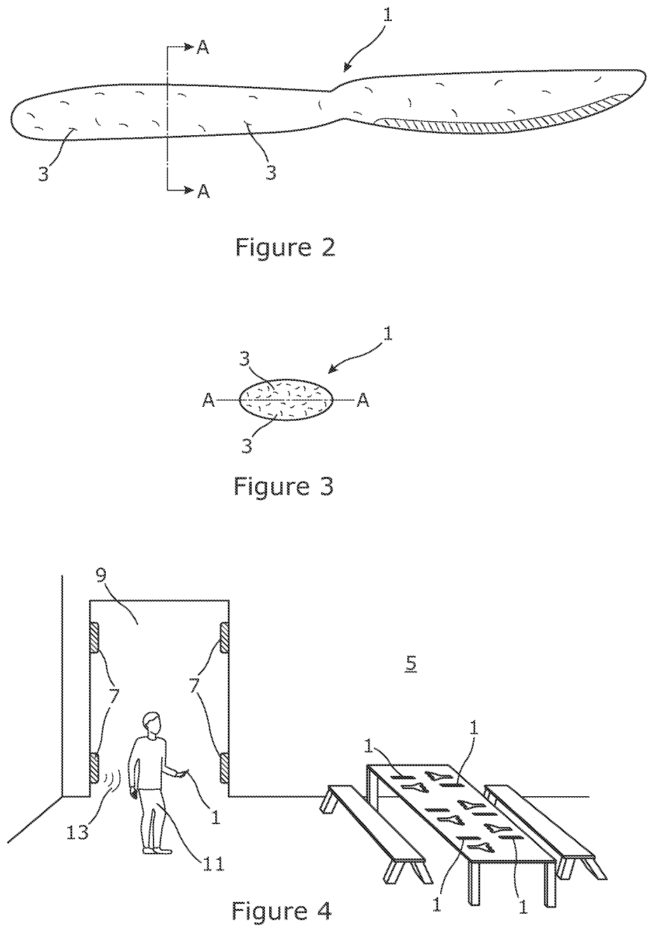

FIG. 2 illustrates a utensil formed in accordance with an embodiment of the present invention;

FIG. 3 illustrates a cross-section along line A-A of the utensil of FIG. 2 in accordance with an embodiment of the present invention; and

FIG. 4 illustrates a secure area having a system implemented an a number of utensils provided in accordance with embodiments of the present invention.

Referring now firstly to FIG. 1, there is shown an example of a conventional utensil, formerly a standard plastic table knife A, which may be provided for use in secure locations or restricted environments such as prisons, post-security airport lounges or other secure facilities, and which may subsequently be taken and adapted for an ulterior use. In this case, and which is common in prisons and young offender facilities, the knife A can be adapted for use as an offensive weapon. This is a serious problem as discussed above. The present invention provides a utensil shown in one example as a table knife 1 in FIG. 2, which is provided for use within secure areas such as those described above. It will be understood that forks, spoons and other utensils for the preparation, serving and/or consumption of food and/or drink may also be formed in the same manner. The knife 1 is formed from a plastics or other polymeric material, and embedded within the plastics material, throughout the knife 1, there is provided a plurality of metal detectable and/or X-ray detectable material 3. The material 3 is provided such that if an attempt is made to remove the knife 1 from the secure area 5, detection apparatus 7 located at exits 9 from the secure area 5 will detect the presence of the knife 1, alerting security personnel and preventing removal of the knife 1 and any subsequent adaptation of the same for and ulterior/violent purpose. Thus, the invention serves to provide a utensil, shown in the figures as a knife 1, which may be used for its intended purpose and makes it particularly difficult to be taken, adapted/altered for use for another purpose, at least without detection upon attempted removal from the secure area 5. The secure area 5 may be any of a canteen, workshop, lounge area or other room within a larger building or environment for which security and/or safety is paramount, and removal of the utensil 1 from the secure area to another area needs to be prevented.

The level of metal detectable particles and/or X-ray detectable material 3 within the utensil 1 will be provided to be sufficient to ensure that the utensil 1, or at least a portion thereof will be detectable by metal detection and/or X-ray detection apparatus 7. The detection apparatus 7 provided will have known detection parameters such that only utensils 1 which are known to be detectable by the detection apparatus 7 will be made available in the secure area 5, thereby ensuring that the utensil Is or portions thereof are detected by the detection apparatus 7 which is in use at that time. Typically, the metal particles which are used and provided within the utensil 1 are ferrous metals or metal-compounds such as iron oxide derivatives, for example, magnetite (Fe₂O₃). The X-ray detectable material may be provided from iodine or barium derivatives, for example, barium sulphate (BaSO₄). The metal detectable particles and/or X-ray detectable material is embedded throughout the utensil 1 such that after any attempt to shave, snap, cut, sharpen, reshape or otherwise alter the shape, size or appearance of the utensil 1, the metal detectable particles and/or X-ray detectable material will remain present within the altered form of the utensil 1, and thus be detectable by the detection apparatus 7, in use.

The utensil 1 forms part of a larger system provided to detect the attempted removal of such an item from a secure area 5. The system further includes the provision of the detection apparatus 7 located at one or more entrances to or exits 9 from the secure area 5. Thus, as any attempt is made to remove a utensil 1 from the secure area 5 by an unauthorised person 11, the utensil 1 is detected by the detection apparatus 7 once it is brought within range of detection 13 of the apparatus. Notification means are provided associated with the detection apparatus 7, such that in use, as a utensil 1 is attempted to be taken from the secure area 5, it will be detected and the apparatus will notify security personnel of the detection, enabling them to prevent the removal of the utensil 1 from the secure area 5. As mentioned above, the secure area 5 is provided to be a canteen, dining area, workshop or specific room or rooms in which the utensil 1 may be required to be utilised, within a prison, jail, penitentiary, or other such restricted location. In other embodiments of the invention, the secure area 5 may be provided to be within an airport location after the point where standard security checks are carried out.

The present invention therefore provides a means by which to detect the attempted removal of an item or items in the form of, for example, a standard utensil 1 from a secure area 5 to be taken into another area for an alternative use. The system is particular advantageous in that even if a degree of alteration or manipulation of the item or items is successfully achieved by a person 11 within the secure area 5, metal detectable particles and/or X-ray detectable material will still be present in a sufficient amount throughout the altered or manipulated utensil 1, to be detected by the detection apparatus 7 upon the attempted removal from the secure area 5 of that utensil 1. The present invention has particular use in, for example, a prison environment wherein standard culinary utensils may be attempted to be taken from a canteen or dining area to be reshaped into an offensive weapon for use in another area of the prison environment—the present invention serves to prevent such instances from occurring and thus substantially reduce the occurrence of potentially violent incidents within that environment.

1. A system for detecting the removal of an item or items from a secure area, said system including:
a secure area in which said item or items are located;
one or more entrances to and/or exits from said secure area;
one or more items, said items provided to be formed of a plastics or other polymeric material;
said item or items further including a plurality of metal detectable particles and/or X-ray detectable material embedded within the plastics material; and
detection or sensor apparatus located at the one or more entrances to and/or exits of said secure area, arranged to detect or sense the passage of metal detectable particles and/or X-ray detectable material therethrough, in use.

2. A system according to claim 1, wherein when an attempt is made to remove the item or items from the secure area, the said detection or sensor apparatus located at the entrances and/or exits from the secure area will detect their presence, in use.

3. A system according to claim 1, wherein said item or items are formed as utensils to be used during the preparation, serving and/or consumption of food and/or drink within the secure area.

4. A system according to claim 1, wherein said secure area is provided to be a canteen, dining area, workshop or specific room or rooms in which said item or items may be required to be utilised or the like within a prison, jail, penitentiary, or other such restricted location.

5. A system according to claim 1, wherein said secure area is provided to be within an airport location after the point where standard security checks are carried out.

6. A system according to claim 1, wherein said metal detectable particles and/or X-ray detectable material is embedded throughout the item or items such that after any attempt to shave, snap, cut, sharpen, reshape or otherwise alter the shape, size or appearance of the item or items, the said metal detectable particles and/or X-ray detectable material will remain present within the altered item or items, and thus be detectable by the detection or sensor apparatus, in use.

7. A system according to claim 1, wherein notification means are provided associated with said detection or sensor apparatus.

8. A system according to claim 1, wherein in use, as an item or items comprising the metal detectable particles and/or X-ray detectable material is attempted to be taken from the secure area, said item or items will be detected and the apparatus will notify security personnel of the detection, enabling them to prevent or deter the removal of the item from the secure area.

9. A system according to claim 1, wherein the detection or sensor apparatus used to attempt to detect said utensils or portions thereof, will be known and have known detection parameters such that only utensils which are known to be detectable by said apparatus will be made available in the secure area and thereby ensure that the utensils or portions thereof are detected by the detection apparatus which is in use at that time, in use.

10. A utensil provided for use in an intended purpose in a secure area, said utensil formed of a plastics or other polymeric material and in a manner to allow the same to be useable for its intended purpose, and said utensil further including embedded within the plastics material, a plurality of metal detectable particles and/or X-ray detectable material, such that when an attempt is made to remove the same from the secure area, detection apparatus located at exits from the secure area will detect the presence of said utensil, in use.

11. A utensil according to claim 10, wherein the level of metal detectable particles and/or X-ray detectable material will be sufficient so as to ensure that the utensil and a predefined size or portion of the material, is detectable by metal detection and/or X-ray detection apparatus, in use.

12. A utensil according to claim 10, wherein the metal particles which are used are ferrous metals or metal-compounds.

13. A utensil according to claim 12, wherein said ferrous metals or metal compounds may include iron oxide derivatives.

14. A utensil according to claim 10, wherein said metal-detectable particles are provided as particles of magnetite (Fe₂O₃).

15. A utensil according to claim 10, wherein said X-ray detectable material is provided from iodine or barium derivatives.

16. A utensil according to claim 10, wherein said X-ray detectable material is barium sulphate (BaSO₄).

17. A set of culinary utensils:
said utensils provided for the preparation, serving and/or consumption of food and/or drink in a secure area;
said utensils formed of a plastics or other polymeric material and in a manner to allow the same to be useable for their intended purpose;
said utensils further including embedded within the plastics material, a plurality of metal detectable particles and/or X-ray detectable material, arranged such that when an attempt is made to remove the same from the secure area, detection apparatus located at entrances and/or exits from the secure area will detect the presence of said utensils.
